(19) United States
(12) Patent Application Publication
(10) Pub. No.: US 2019/0366463 A1
(43) Pub. Date: Dec. 5, 2019

(54) GOUGING-LESS COMPLETE PENETRATION WELDING METHOD, AND WELDED JOINT

(71) Applicant: Kabushiki Kaisha Kobe Seiko Sho (Kobe Steel, Ltd.), Kobe-shi (JP)

(72) Inventors: Hirohisa KISHIKAWA, Hyogo (JP); Daisuke UMEKAWA, Hyogo (JP); Shigeto TAKADA, Hyogo (JP)

(73) Assignee: Kabushiki Kaisha Kobe Seiko Sho (Kobe Steel, Ltd.), Kobe-shi (JP)

(21) Appl. No.: 16/462,338

(22) PCT Filed: Nov. 8, 2017
(86) PCT No.: PCT/JP2017/040190

§ 371 Date: May 20, 2019

(30) Foreign Application Priority Data
Nov. 21, 2016 (JP) 2016-225962

(51) Int. Cl. B23K 9/02; B23K 9/095; B23K 9/025

(52) U.S. Cl. CPC B23K 9/0216; B23K 9/1006; B23K 9/0256; B23K 9/095

(57) ABSTRACT

A gouging-less full-penetration welding method for welding a first steel plate and a second steel plate without performing gouging includes: a step of repeating weaving at a welding current of 130 to 300 A between the first steel plate and the second steel plate, thereby forming an initial weld bead having a continuous single or a plurality of continuous layers between the first steel plate and the second steel plate; a step of conducting single- or multi-layer welding from a front side; and a step of conducting single- or multi-layer welding from a back side.

### TECHNICAL FIELD

The present invention relates to a gouging-less full-penetration welding method in which a single bevel groove or a double bevel groove is welded without gouging, and to a weld joint.

### BACKGROUND ART

In conventional full-penetration welding for producing a single-bevel groove joint and a double-bevel groove joint without using a backing metal, a first layer was formed by welding, and subsequently the first-layer portion and weld defects in the first layer were removed to clean the portion (groove) to be welded (back chipping, gouging) from the side of the plates opposite to the side where the first welding was performed, thereby optimizing the condition of the groove portion, and thereafter welding was conducted again.

However, the full-penetration welding with gouging is inferior in welding efficiency to welding with a backing metal and requires an advanced technique and experience for performing the gouging and the re-welding. Furthermore, the gouging accuracy (depth and surface shape) is unstable and when the root gap is wide due to low assembly accuracy, there has been a problem in that burning through to the back side is prone to occur, which causes weld defects or makes the gouging difficult. In the case of welding with a welding robot, there is a problem in that it is difficult to set an aim position on the back side, besides the same problem as described above.

Patent Literature 1 and Patent Literature 2 disclose gouging-less full-penetration welding methods. Patent Literature 1 discloses a gouging-less full-penetration welding method for welding a T joint having a square groove, single bevel groove, or double bevel groove by high-current pulse MAG welding. In the method, the welding heat input, back-side bead leg length, welding current, welding speed, pulse conditions, wire aim position, movement angle, and shielding gas flow rate are regulated to thereby realize defect-free welding without necessitating back chipping and improve the welding efficiency.

Patent Literature 2 discloses a double-groove welding method in which a double bevel groove joint can be welded from both sides by automatic welding without conducting gouging. A first plate and a second plate, in which a double bevel groove has been formed, are welded from both sides using a pair of welding torches. In this method, the root face in the groove portion is made to have a width within the range of 2 to 4 mm and the welding current is regulated so as to be within the range of 280 to 320 A, thereby enabling the grooves on both sides to be automatically welded at one time without gouging. Thus, a reduction in welding time is attained.

### CITATION LIST

### Patent Literature

Patent Literature 1: JP-A-2007-38288

Patent Literature 2: JP-A-H11-58001

### SUMMARY OF INVENTION

### Technical Problem

However, the welding method according to Patent Literature 1 has limitations in welding conditions and cannot be used when the root gap is wide or the root gap is uneven, and if used in such a case, voids may be generated due to burning through. In addition, the problem that it is difficult to set an aim position on the back side in welding with a welding robot remains unsolved.

Meanwhile, the welding method according to Patent Literature 2 has drawbacks in that this method has a low degree of freedom in groove shape and, for example, is not applicable to single bevel grooves. There has hence been room for improvement.

An object of the present invention, which has been achieved in view of the problems described above, is to provide a gouging-less full-penetration welding method in which semi-automatic welding and automatic welding is applicable to either of single bevel grooves and double bevel grooves while inhibiting the generation of weld defects, even when the root gap is wide or when the root gap is uneven due to low assembly accuracy, and a weld joint.

### Solution to Problem

The object of the present invention is accomplished with the following configurations.

(1) A gouging-less full-penetration welding method for welding a first steel plate and a second steel plate without performing gouging, wherein the first steel plate and the second steel plate form a single or double bevel groove, and when a side where the single bevel groove is open or a side where the double bevel groove has a smaller groove angle is referred to as a front side, the method including: a step of repeating weaving at a welding current of 130 to 300 A between the first steel plate and the second steel plate, thereby forming an initial weld bead having a continuous single or a plurality of continuous layers between the first steel plate and the second steel plate, wherein in the weaving, on the front side between the first steel plate and the second steel plate, a welding torch is moved forward in a welding direction to a weaving end of the second steel plate and, after arrival at the weaving end of the second steel plate, the welding torch is moved backward in the welding direction to a weaving end of the first steel plate; a step of conducting single- or multi-layer welding from the front side; and a step of conducting single- or multi-layer welding from a back side.
(2) The gouging-less full-penetration welding method according to (1), wherein the initial weld bead is formed by welding with a consumable electrode fed from the welding torch, and wherein the welding torch has a torch angle within the range of (front-side groove angle)/2 to (front-side groove angle)/2+5°.
(3) The gouging-less full-penetration welding method according to (1) or (2), wherein the initial weld bead is formed by welding with a consumable electrode fed from the welding torch, and wherein the weaving is controlledly conducted so that an extension of the consumable electrode from the welding torch is constant.
(4) The gouging-less full-penetration welding method according to any one of (1) to (3), wherein in the weaving: in moving the welding torch forward in the welding direction to the weaving end of the second steel plate, a forward movement angle β, which is an angle formed by a track of the welding torch and the welding direction, is 185° or more and 250° or less; in moving the welding torch backward in the welding direction to the weaving end of the first steel plate, a backward movement angle α, which is an angle formed by the track of the welding torch and a direction opposite to the welding direction, is 5° or more and 85° or less; and the backward movement angle α and the forward movement angle β satisfies a relationship of α>(β−180).
(5) The gouging-less full-penetration welding method according to any one of (1) to (4), wherein in the weaving, at least either of a first arc voltage at the weaving end of the first steel plate and a second arc voltage at the weaving end of the second steel plate is controlled to be higher or lower than an arc voltage at the midpoint between the two weaving ends, so that the first arc voltage is lower than the second arc voltage.
(6) The gouging-less full-penetration welding method according to any one of (1) to (5), wherein the single- or multi-layer welding from the back side is conducted at a back-side welding current of 280 to 450 A, and wherein a ratio of the back-side welding current to the welding current for forming the initial weld bead, (back-side welding current)/(welding current for initial weld bead), is 1.2 to 2.6.
(7) The gouging-less full-penetration welding method according to any one of (1) to (6), wherein the initial weld bead protrudes on the back side in an amount of less than 4 mm.
(8) The gouging-less full-penetration welding method according to any one of (1) to (7), wherein a root gap between the first steel plate and the second steel plate is 10 mm or less.
(9) The gouging-less full-penetration welding method according to any one of (1) to (8), wherein at least the step of forming the initial weld bead includes: a step of detecting a root gap by sensing using a welding robot before the welding; and a step of controlling the welding current for forming the initial weld bead depending on the root gap.
(10) The gouging-less full-penetration welding method according to (9), wherein when the root gap exists, the welding current for forming the initial weld bead is controlled so that a ratio of the value of the root gap to the welding current for forming the initial weld bead is 0.050 or less.
(11) A weld joint welded by the gouging-less full-penetration welding method according to any one of (1) to (10).

### Advantageous Effects of Invention

According to the gouging-less full-penetration welding method of the present invention, the welding for a single or double bevel groove is conducted in the following manner: repeating weaving at a welding current of 130 to 300 A between the first steel plate and the second steel plate, thereby forming an initial weld bead having a continuous single or a plurality of continuous layers between the first steel plate and the second steel plate, and in the weaving, on the front side between the first steel plate and the second steel plate, a welding torch is moved forward in a welding direction to a weaving end of the second steel plate and, after arrival at the weaving end of the second steel plate, the welding torch is moved backward in the welding direction to a weaving end of the first steel plate; and thereafter conducting front-side single- or multi-layer welding and back-side single- or multi-layer welding. Thus, the full-penetration welding can be efficiently carried out while inhibiting the generation of weld defects such as burning through, without performing gouging.

The weld joint of the present invention, which is free from weld defects such as burning through, can be efficiently obtained because the weld joint is one produced by the gouging-less full-penetration welding method described above.

### BRIEF DESCRIPTION OF DRAWINGS

FIG. 1 schematically illustrates a procedure according to the present invention for welding a joint having a single bevel groove.

FIG. 2 schematically illustrates a procedure according to the present invention for welding a joint having a double bevel groove.

FIG. 3 is a sectional view illustrating the amount in which an initial weld bead formed in a double bevel groove protrudes on the back side.

FIG. 4A is a front view illustrating the track of a welding torch in forming an initial weld bead by weaving.

FIG. 4B is a view taken in the direction of the arrow IV of FIG. 4A.

### DESCRIPTION OF EMBODIMENTS

A gouging-less full-penetration welding method according to one embodiment of the present invention is described below by reference to the drawings.

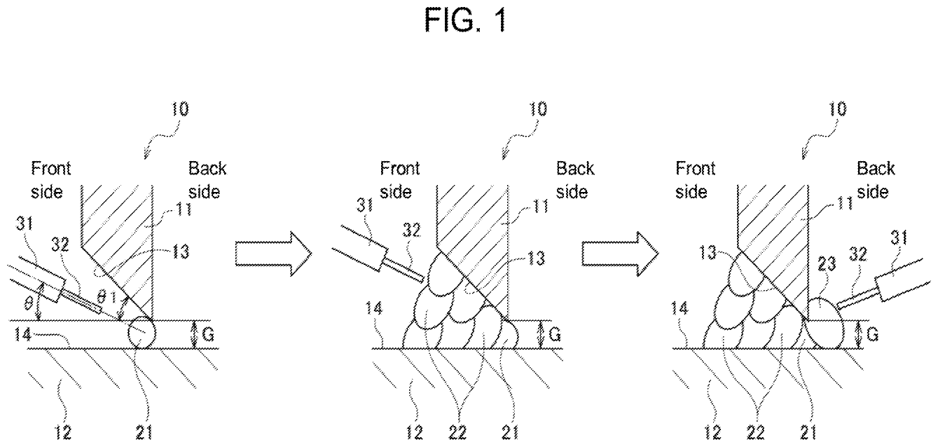

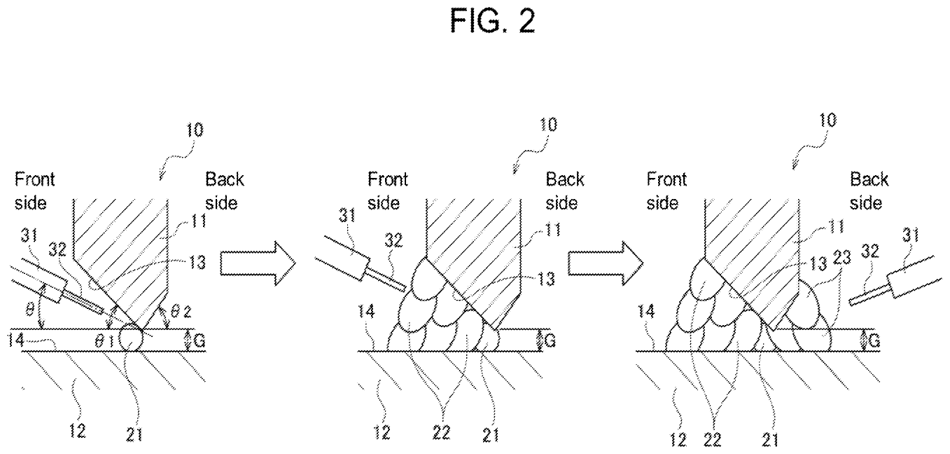

As illustrated in FIG. 1 and FIG. 2, a weld joint 10 according to this embodiment is formed by bringing an edge surface 13 of a first steel plate 11 near to a flat surface 14 of a second steel plate 12, which is flat, to dispose the first and second steel plates in a T-shaped arrangement, thereby forming a single or double bevel groove, and subjecting the thus-formed groove portion to full-penetration welding without using a backing material.

The weld form in the groove portion is composed of a plurality of weld beads 21, 22, and 23 formed by a plurality of welding passes.

FIG. 1 illustrates a welding procedure for the case of forming a single bevel groove between the end surface 13 of the first steel plate 11 and the flat surface 14 of the second steel plate 12. FIG. 2 illustrates a welding procedure for the case of forming a double bevel groove between the end surface 13 of the first steel plate 11 and the flat surface 14 of the second steel plate 12. For convenience of explanation, a front side and a back side are defined as follows: in the case of a single bevel groove, the side where the groove is open referred to as a front side; in the case of a double bevel groove, the side where the groove has a smaller groove angle is referred to as a front side; and the side opposite to the front side is referred to as a back side. However, in the case of a double bevel groove having the same groove angle on both sides, either side may be referred to as a front side. The front-side groove angle θ1 of the single or double bevel groove and the back-side groove angle θ2 of the double bevel groove are set at any values.

This embodiment employs gas-shielded arc welding in which welding is conducted while feeding a consumable electrode 32 from a welding torch 31, as an arc welding method for conducting welding passes of the groove portion. Specifically, when a voltage is applied to between the consumable electrode 32 and the groove from a welding power source (not illustrated), an arc current flows to generate an arc, so that welding is performed.

A wire as the consumable electrode 32 may be a solid wire or a flux-cored wire (FCW).

As a shielding gas, any gas, such as CO₂ gas or an Ar/CO₂ mixed gas, may be used.

Specifically, as illustrated in FIG. 1 and FIG. 2, a continuous initial weld bead 21 is first formed between the first steel plate 11 and the second steel plate 12 from the front side, thereby bridging the root gap G to block the groove portion. This initial weld bead 21 is formed while weaving the welding torch 31, at a welding current set at 130 to 300 A. Thus, not only the initial weld bead 21 is inhibited from having weld defects such as blowholes or slag entrainment, but also the root gap G is inhibited from causing defects in back-side bead shape, such as voids due to burning through. Preferably, as the lower limit of the welding current for forming the initial weld bead 21, the welding current is 150 A or higher, and as the upper limit thereof, it is 280 A or less.

It is preferred to form an initial weld bead 21 even when the root gap G is 0. The term “welding current” herein means an average current of welding currents including that for the remaining front-side welding and that for the back-side welding, which will be described later. The welding current may be direct current or pulse-waveform current.

Depending on welding conditions, it is necessary to form a root gap G between the first steel plate 11 and the second steel plate 12. Even in such cases, the root gap G can be bridged and welding can be conducted with no burning through, by forming an initial weld bead 21 while weaving the welding torch 31.

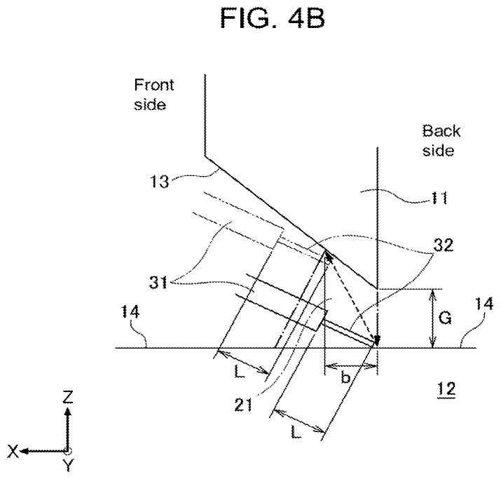

Specifically, the formation of an initial weld bead 21 is conducted by repeating weaving to weld. As illustrated in FIG. 4A and FIG. 4B, in the weaving, on the front side between the first steel plate 11 and the second steel plate 12, the welding torch 31 is moved forward in the welding direction (direction Y) at a forward movement angle β almost along the groove shape to a weaving end P₂ of the second steel plate 12, and then moved from the weaving end P₂ backward in the welding direction at a backward movement angle α to a weaving end P₁ of the first steel plate 11.

As illustrated in FIG. 4A, the forward movement angle β is the angle formed by the track of the welding torch 31 that is moving (downward) from the first steel plate 11 (weaving end P₁) to the second steel plate 12 (weaving end P₂) and the direction opposite to the welding direction Y. The backward movement angle α, is the angle formed by the track of the welding torch 31 that is moving (upward) from the second steel plate 12 (weaving end P₂) to the first steel plate 11 (weaving end P₁) and the direction opposite to the welding direction Y.

The forward movement angle β is preferably 185° or more and 250° or less, more preferably 185° or more and 215° or less. The backward movement angle α is preferably 5° or more and 85° or less, more preferably 10° or more and 45° or less.

It is preferable that the backward movement angle α and the forward movement angle β have a relationship of α>(β−180). When the relationship of α>(β−180) is satisfied, welding can be conducted by weaving while moving the welding torch 31 forward along the welding direction Y.

By thus weaving the welding torch 31 by zigzag moving the welding torch 31 obliquely between the first steel plate 11 and the second steel plate 12, an initial weld bead 21 is formed so that a second layer of an initial bead, which is formed by the welding torch movement from the second steel plate 12 to the first steel plate 11, is overlapped on a first layer of the initial weld bead 21, which is formed by the welding torch movement from the first steel plate 11 to the second steel plate 12. Thus, despite the root gap G, the root gap G can be bridged to block the groove portion and a satisfactory initial weld bead 21 is formed without causing burning through.

Although the welding current for the initial weld bead is set at 130 to 300 A, it is preferable that the first arc voltage V₁ at the weaving end P₁ of the first steel plate 11 is lower than the second arc voltage V₂ at the weaving end P₂ of the second steel plate 12 (V₁<V₂). This relationship between the first and second arc voltages V₁ and V₂ can be attained by controlling either of the first and second arc voltages V₁ and V₂ so as to be higher or lower than an arc voltage Vₘ at the midpoint P₃ between the two weaving ends P₁ and P₂.

Thus, by controlling the first arc voltage V₁ at the weaving end P₁, which is located on the edge surface 13 of the first steel plate 11 that faces downward, so as to be lower than the arc voltage Vₘ at the midpoint P₃, undercutting at the weaving end P₁ of the first steel plate 11 is reduced. Meanwhile, by controlling the second arc voltage V₂ at the weaving end P₂, which is located on the flat surface 14 of the second steel plate 12 that faces upward, so as to be higher than the arc voltage Vₘ at the midpoint P₃, overlapping at the weaving end P₂ of the second steel plate 12 is reduced. As a result, an initial weld bead 21 having a satisfactory shape is formed.

It is preferred to conduct the weaving so that the extension L of the consumable electrode 32 from the welding torch 31 is kept constant. Welding is conducted from the second steel plate 12 to the first steel plate 11 (from the weaving end P₂ to the weaving end P₁) at the backward movement angle α while moving the welding torch 31 in the direction (direction X) opposite to the front side by the leg length b of the bead that is formed by welding from the first steel plate 11 to the second steel plate 12 (from the weaving end P₁ to the weaving end P₂) at the forward movement angle β. Thus, the extension L of the consumable electrode 32 can be kept constant. As a result, the arc is stabilized to diminish spattering and the effect of arc tracking is obtained.

Thus, in the weaving, the welding torch 31 is moved downward for welding (from the weaving end P₁ to the weaving end P₂) to apply the arc to the second steel plate 12 and melt a base metal of the second steel plate 12, and thereafter the welding torch 31 is moved upward for welding (from the weaving end P₂ to the weaving end P₁) to thereby fill the root gap G with a weld metal and apply the arc to the first steel plate 11 and melt a base metal of the first steel plate 11. The root gap G between the first steel plate 11 and the second steel plate 12 is thereby bridged.

In forming the initial weld bead 21, the torch angle θ of the welding torch 31 is preferably set at a value within the range of (front-side groove angle θ1)/2 to (front-side groove angle θ1)/2+5°, from the standpoints of reducing weld defects of the initial weld bead 21 and reducing defects in back-side bead shape.

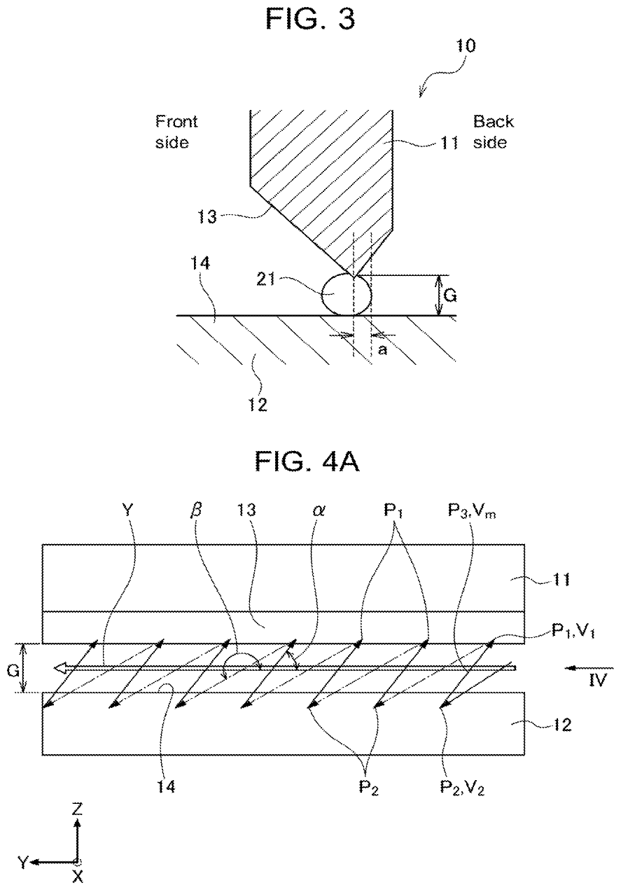

As illustrated in FIG. 3, the protrusion amount a, in which the initial weld bead 21 protrudes on the back side from the position where the root gap G between the first steel plate 11 and the second steel plate 12 is defined, is preferably less than 4 mm. When the protrusion amount a is less than 4 mm, welding from the back side can be conducted without being affected by the back-side bead shape, and complete welding can hence be attained.

From the standpoint of reliably bridging the root gap G of each groove with the initial weld bead 21, the root gap G is preferably 10 mm or less, more preferably 5 mm or less.

Subsequently, as illustrated in FIG. 1 and FIG. 2, welding for forming a single or a plurality of layers (six layers in the embodiments illustrated in the drawings) is conducted from the front side at a welding current of 280 to 400 A to form weld bead 22.

Furthermore, as illustrated in FIG. 1 and FIG. 2, overlaying for forming a single or a plurality of layers (a single layer in the embodiment illustrated in FIG. 1, and three layers in the embodiment illustrated in FIG. 2) is conducted from the back side at a back-side welding current of 280 to 450 A, which is higher than the welding current for forming the initial weld bead, to form weld bead 23. In this operation, it is preferable that the ratio of the back-side welding current to the welding current for forming the initial weld bead, (back-side welding current)/(welding current for initial weld bead), is 1.2 to 2.6. By thus conducting welding from the back side at a high back-side welding current on the initial weld bead 21, formed by welding at a relatively low current and having a small penetration depth, gouging-less full-penetration welding is conducted without causing any weld defects such as burning through, incomplete penetration or weld cracking.

The gouging-less full-penetration welding method described above is applicable not only to manual welding but also semiautomatic or automatic welding using a welding robot. When the gouging-less full-penetration welding is performed as semiautomatic or automatic welding, the formation of an initial weld bead 21 from the front side may be conducted by detecting a root gap G by sensing before welding, and controlling the welding current for forming the initial weld bead depending on the detected root gap G Examples of the sensing before welding include touch sensing and laser sensing.

Specifically, when there is a root gap, the welding current for forming an initial weld bead 21 is controlled so that the ratio of the root gap G to the welding current is 0.050 or less, in forming the initial weld bend 21. Thus, a proper initial weld bead 21 can be formed with a semiautomatic or automatic welding machine, and gouging-less full-penetration welding without weld defects can be performed.

For detecting the root gap G; a common technique is used with a welding torch 31 supporting a consumable electrode 32 having a predetermined extension.

As described above, according to the gouging-less full-penetration welding method of this embodiment, the welding for a single or double bevel groove is conducted in the following manner: repeating weaving at a welding current of 130 to 300 A between the first steel plate and the second steel plate, thereby forming an initial weld bead having a continuous single or a plurality of continuous layers between the first steel plate and the second steel plate, and in the weaving, on the front side between the first steel plate and the second steel plate, a welding torch is moved forward in a welding direction to a weaving end of the second steel plate and, after arrival at the weaving end of the second steel plate, the welding torch is moved backward in the welding direction to a weaving end of the first steel plate; and thereafter conducting front-side single- or multi-layer welding and back-side single- or multi-layer welding. Thus, the full-penetration welding can be efficiently carried out while inhibiting the generation of weld defects such as burning through, without performing gouging, i.e., in a gouging-less manner.

The present invention is not limited to the embodiment described above, and modifications, improvements and the like can be suitably made therein.

In the embodiment described above, an initial weld bead 21 was formed, weld bead 22 was then formed on the front side, and thereafter weld bead 23 was formed on the back side. However, the order of welding is not limited thereto. The following method may be used: after an initial weld bead 21 is formed, weld bead 23 is formed on the back side and weld bead 22 is thereafter formed on the front side.

Although the embodiment described above illustrates an application to T joints, the present invention is applicable to butt joints of any shapes, such as, for example, a joint including a first steel plate and a second steel plate which are disposed in a butt arrangement to form a square groove between edge surfaces of the two steel plates.

Furthermore, in the embodiment described above, the edge surface 13 of the first steel plate 11 and the flat surface 14 of the second steel plate 12 face each other in upside/downside directions to perform horizontal welding. However, there is no limitation on welding position. For example, the edge surface 13 of the first steel plate 11 and the flat surface 14 of the second steel plate 12 may be made to face each other in horizontal directions to perform flat welding.

### EXAMPLES

In order to demonstrate the effectiveness of the present invention, welding tests were conducted under various welding conditions while changing groove shape (groove angle and groove depth), root gap, welding position, torch angle, welding current for forming an initial weld bead, back-side welding current, shielding gas, state of initial weld bead (back-side protrusion amount, number of bead layers), whether weaving was performed or not, weaving conditions (backward movement angle α, forward movement angle β), whether the extension of a consumable electrode was controlled or not, whether arc voltage at a weaving end was controlled or not, etc. Weaving was basically performed, and welding with no weaving was conducted for the purpose of comparison. The weaving was normal weaving in which the torch was shuttled approximately perpendicularly to the welding direction. In the case of single bevel grooves, the groove angle was 40° or 45°. In the case of double bevel grooves, each workpiece was made to have a front-side groove angle of 40°, front-side groove depth of 21 mm, back-side groove angle of 50°, and back-side groove depth of 11 mm.

Weld quality was evaluated by visually inspecting the appearance to examine bridging (gap blocking), initial-layer weld defects (undercutting, lapping), and back-side bead shape after formation of the initial weld bead. With respect to the bridging, the work in which the gap had been bridged and the bead appearance was satisfactory is indicated by A, that in which the gap had been bridged although the bridge was insufficient is indicated by B, and that in which the gap remained unbridged is indicated by C. With respect to the initial-layer weld defects, the initial layer having no defect is indicated by A, that having acceptable amount of weld defects is indicated by B, and that having undercutting or lapping is indicated by C. With respect to the back-side bead shape after formation of the initial weld bead (hereinafter referred to simply as “back-side bead shape”), the back-side bead having no problem is indicated by A, that having acceptable-level gentle undulations is indicated by B, and that having voids due to burning through and that having enhanced ruggedness are indicated by C. The results of the tests are shown in Table 1 and Table 2 together with the various welding conditions.

TABLE 1

| | | | | | | | | Welding | Torch angle | |
|---|---|---|---|---|---|---|---|---|---|---|
| | | Workpiece | | | | | | position | Actual | |
| | | Groove | Front-side groove | Back-side | Front-side groove | Back-side groove | Root | Horizontal/ | torch | |
| No. | Wire | shape | angle (°) | groove angle (°) | depth (mm) | depth (mm) | gap | flat | angle | *1 |
| 1 | solid | double | 40 | 50 | 21 | 11 | 3 | flat | 23 | A |
| | | bevel | | | | | | | | |
| 2 | solid | double | 40 | 50 | 21 | 11 | 3 | flat | 23 | A |
| | | bevel | | | | | | | | |
| 3 | solid | double | 40 | 50 | 21 | 11 | 4 | flat | 23 | A |
| | | bevel | | | | | | | | |
| 4 | solid | double | 40 | 50 | 21 | 11 | 3 | flat | 23 | A |
| | | bevel | | | | | | | | |
| 5 | solid | double | 40 | 50 | 21 | 11 | 3 | flat | 23 | A |
| | | bevel | | | | | | | | |
| 6 | solid | double | 40 | 50 | 21 | 11 | 3 | flat | 23 | A |
| | | bevel | | | | | | | | |
| 7 | solid | double | 40 | 50 | 21 | 11 | 3 | flat | 23 | A |
| | | bevel | | | | | | | | |
| 8 | solid | double | 40 | 50 | 21 | 11 | 3 | flat | 23 | A |
| | | bevel | | | | | | | | |
| 9 | solid | double | 40 | 50 | 21 | 11 | 3 | flat | 23 | A |
| | | bevel | | | | | | | | |
| 10 | solid | double | 40 | 50 | 21 | 11 | 3 | horizontal | 23 | A |
| | | bevel | | | | | | | | |
| 11 | solid | double | 40 | 50 | 21 | 11 | 1 | horizontal | 23 | A |
| | | bevel | | | | | | | | |
| 12 | solid | single | 40 | — | — | — | 1 | horizontal | 20 | A |
| | | bevel | | | | | | | | |
| 13 | solid | single | 45 | — | — | — | 1 | horizontal | 25 | A |
| | | bevel | | | | | | | | |
| 14 | solid | single | 40 | — | — | — | 1 | horizontal | 20 | A |
| | | bevel | | | | | | | | |
| 15 | solid | double | 40 | 50 | 21 | 11 | 3 | horizontal | 23 | A |
| | | bevel | | | | | | | | |
| 16 | solid | single | 40 | — | — | — | 1 | horizontal | 20 | A |
| | | bevel | | | | | | | | |
| 17 | solid | double | 40 | 50 | 21 | 11 | 3 | flat | 23 | A |
| | | bevel | | | | | | | | |
| 18 | solid | double | 40 | 50 | 21 | 11 | 2 | flat | 23 | A |
| | | bevel | | | | | | | | |
| 19 | solid | double | 40 | 50 | 21 | 11 | 2 | flat | 23 | A |
| | | bevel | | | | | | | | |
| 20 | solid | double | 40 | 50 | 21 | 11 | 0.5 | flat | 23 | A |
| | | bevel | | | | | | | | |
| 21 | solid | double | 40 | 50 | 21 | 11 | 3 | flat | 18 | C |
| | | bevel | | | | | | | | |
| 22 | solid | double | 40 | 50 | 21 | 11 | 0.5 | flat | 25 | A |
| | | bevel | | | | | | | | |
| 23 | FCW | double | 40 | 50 | 21 | 11 | 2 | flat | 23 | A |
| | | bevel | | | | | | | | |
| 24 | solid | double | 40 | 50 | 21 | 11 | 2 | flat | 23 | A |
| | | bevel | | | | | | | | |
| 25 | solid | double | 40 | 50 | 21 | 11 | 2 | flat | 23 | A |
| | | bevel | | | | | | | | |
| 26 | solid | double | 40 | 50 | 21 | 11 | 2 | flat | 23 | A |
| | | bevel | | | | | | | | |
| 27 | solid | double | 40 | 50 | 21 | 11 | 2 | flat | 23 | A |
| | | bevel | | | | | | | | |
| 28 | solid | double | 40 | 50 | 21 | 11 | 2 | flat | 20 | A |
| | | bevel | | | | | | | | |
| 29 | solid | double | 40 | 50 | 21 | 11 | 6 | flat | 23 | A |
| | | bevel | | | | | | | | |
| 30 | solid | double | 40 | 50 | 21 | 11 | 10 | flat | 23 | A |
| | | bevel | | | | | | | | |
| 31 | solid | double | 40 | 50 | 21 | 11 | 12 | flat | 23 | A |
| | | bevel | | | | | | | | |
| 32 | solid | double | 40 | 50 | 21 | 11 | 2 | flat | 23 | A |
| | | bevel | | | | | | | | |
| 33 | solid | double | 40 | 50 | 21 | 11 | 2 | flat | 30 | C |
| | | bevel | | | | | | | | |
| 34 | solid | double | 40 | 50 | 21 | 11 | 2 | flat | 23 | A |
| | | bevel | | | | | | | | |
| 35 | solid | double | 40 | 50 | 21 | 11 | 2 | flat | 23 | A |
| | | bevel | | | | | | | | |
| 36 | solid | double | 40 | 50 | 21 | 11 | 4 | flat | 23 | A |
| | | bevel | | | | | | | | |
| 37 | solid | double | 40 | 50 | 21 | 11 | 3 | flat | 23 | A |
| | | bevel | | | | | | | | |
| 38 | solid | double | 40 | 50 | 21 | 11 | 3 | flat | 23 | A |
| | | bevel | | | | | | | | |
| 39 | solid | double | 40 | 50 | 21 | 11 | 3 | flat | 24 | A |
| | | bevel | | | | | | | | |

| | Welding conditions | | | | | | | |
|---|---|---|---|---|---|---|---|---|
| | | | (Back-side | | | | | |
| | | | welding | | | State of initial weld bead | | |
| | | | current)/ | | | Back-side | | |
| | Welding | Current | (welding | | | protrusion | | |
| | current for | For back- | current | | (Root gap)/(welding | amount of | Number of | |
| | Initial weld | side first | for initial | Shielding | Current for initial | initial weld | Initial weld | Weaving for |
| No. | Bead (A) | Layer (A) | weld bead) | gas | bead) | bead (mm) | Bead layers | Initial layer |
| 1 | 200 | 380 | 1.90 | Ar + CO₂ | 0.015 | 2 | 1 | performed |
| 2 | 200 | 380 | 1.90 | Ar + CO₂ | 0.015 | 2 | 1 | performed |
| 3 | 160 | 380 | 2.38 | Ar + CO₂ | 0.025 | 1 | 1 | performed |
| 4 | 200 | 380 | 1.90 | Ar + CO₂ | 0.015 | 2 | 1 | performed |
| 5 | 200 | 380 | 1.90 | Ar + CO₂ | 0.015 | 2 | 1 | performed |
| 6 | 200 | 380 | 1.90 | Ar + CO₂ | 0.015 | 2 | 1 | performed |
| 7 | 200 | 380 | 1.90 | Ar + CO₂ | 0.015 | 2 | 1 | performed |
| 8 | 200 | 380 | 1.90 | Ar + CO₂ | 0.015 | 2 | 1 | performed |
| 9 | 200 | 380 | 1.90 | Ar + CO₂ | 0.015 | 2 | 1 | performed |
| 10 | 160 | 280 | 1.75 | CO₂ | 0.019 | 3 | 1 | performed |
| 11 | 275 | 280 | 1.02 | CO₂ | 0.004 | 0 | 1 | performed |
| 12 | 220 | 300 | 1.36 | CO₂ | 0.005 | 0 | 1 | performed |
| 13 | 220 | 300 | 1.36 | CO₂ | 0.005 | 0 | 1 | performed |
| 14 | 240 | 300 | 1.25 | CO₂ | 0.004 | 0 | 1 | performed |
| 15 | 170 | 280 | 1.65 | Ar + CO₂ | 0.018 | 3 | 1 | performed |
| 16 | 230 | 300 | 1.30 | Ar + CO₂ | 0.004 | 0 | 1 | performed |
| 17 | 150 | 380 | 2.53 | Ar + CO₂ | 0.020 | 3 | 1 | performed |
| 18 | 190 | 370 | 1.95 | Ar + CO₂ | 0.011 | 2 | 1 | performed |
| 19 | 210 | 380 | 1.81 | Ar + CO₂ | 0.010 | 2 | 1 | performed |
| 20 | 150 | 400 | 2.67 | Ar + CO₂ | 0.003 | 2 | 1 | performed |
| 21 | 210 | 380 | 1.81 | Ar + CO₂ | 0.014 | 3 | 1 | performed |
| 22 | 250 | 380 | 1.52 | Ar + CO₂ | 0.002 | 2 | 1 | performed |
| 23 | 210 | 450 | 2.14 | Ar + CO₂ | 0.010 | 2 | 1 | performed |
| 24 | 210 | 380 | 1.81 | Ar + CO₂ | 0.010 | 2 | 1 | performed |
| 25 | 180 | 250 | 1.39 | Ar + CO₂ | 0.011 | 1 | 1 | performed |
| 26 | 210 | 500 | 2.38 | Ar + CO₂ | 0.010 | 2 | 1 | performed |
| 27 | 180 | 300 | 1.67 | Ar + CO₂ | 0.011 | 1 | 1 | performed |
| 28 | 260 | 350 | 1.35 | Ar + CO₂ | 0.008 | 4 | 1 | performed |
| 29 | 220 | 380 | 1.73 | Ar + CO₂ | 0.027 | 3 | 2 | performed |
| 30 | 220 | 420 | 1.91 | Ar + CO₂ | 0.045 | 3 | 3 | performed |
| 31 | 220 | 450 | 2.05 | Ar + CO₂ | 0.055 | 4 | 4 | performed |
| 32 | 210 | 380 | 1.81 | Ar + CO₂ | 0.010 | 2 | 1 | performed |
| 33 | 220 | 350 | 1.59 | Ar + CO₂ | 0.009 | 2 | 1 | performed |
| 34 | 130 | 350 | 2.69 | Ar + CO₂ | 0.015 | 2 | 1 | performed |
| 35 | 300 | 350 | 1.17 | Ar + CO₂ | 0.007 | 2 | 1 | performed |
| 36 | 160 | 380 | 2.38 | Ar + CO₂ | 0.025 | 2 | 1 | not |
| | | | | | | | | performed |
| 37 | 160 | 380 | 2.38 | Ar + CO₂ | 0.019 | 2 | 1 | not |
| | | | | | | | | performed |
| 38 | 160 | 380 | 2.38 | Ar + CO₂ | 0.019 | 2 | 1 | performed |
| 39 | 160 | 380 | 2.38 | Ar + CO₂ | 0.019 | 2 | 1 | performed |

*1: Torch angle within the range of (front-side groove angle)/2 to (front-side groove angle)/2 + 5° . . . A.

TABLE 2

| | | | | | | | | Evaluation | | |
|---|---|---|---|---|---|---|---|---|---|---|
| | | | | | | | | | | Back-side |
| | | | | | | | | | Initial-layer weld | bead shape |
| | | | | | | | | | defects (including | after |
| | Weaving conditions | | | | | | Control of | Bridging | undercutting, | formation of |
| | Weaving | | | | | Control of | voltage at | (gap | lapping, etc. of | initial weld |
| No. | width | Frequency | α | β | α > (β − 180) | extension | both ends | blocking) *1 | initial layer) | bead *2 |
| 1 | 3 | 1.5 | 5 | 185 | satisfied | performed | performed | A | A: no defect | A |
| 2 | 3 | 1.5 | 18 | 193 | satisfied | performed | performed | A | A: no defect | A |
| 3 | 3 | 2.5 | 38 | 205 | satisfied | performed | performed | A | A: no defect | A |
| 4 | 3 | 2.5 | 82 | 224 | satisfied | performed | performed | A | A: no defect | A |
| 5 | 3 | 2.5 | 75 | 250 | satisfied | performed | performed | A | A: no defect | A |
| 6 | 3 | 2.5 | 136 | 278 | satisfied | performed | performed | B | A: no defect | A |
| 7 | 3 | 1.5 | 3 | 180 | satisfied | performed | performed | B | A: no defect | A |
| 8 | 3 | 2.5 | 38 | 205 | satisfied | not performed | performed | B | A: no defect | B |
| 9 | 3 | 2.5 | 38 | 205 | satisfied | performed | not | B | A: no defect | A |
| | | | | | | | performed | | | |
| 10 | 3 | 2.5 | 38 | 205 | satisfied | performed | performed | A | A: no defect | A |
| 11 | 3 | 2.5 | 38 | 205 | satisfied | performed | performed | B | B: acceptable | B |
| 12 | 3 | 2.5 | 38 | 205 | satisfied | performed | performed | A | A: no defect | A |
| 13 | 3 | 2.5 | 38 | 205 | satisfied | performed | performed | A | A: no defect | A |
| 14 | 3 | 2.5 | 38 | 205 | satisfied | performed | performed | A | A: no defect | A |
| 15 | 3 | 2.5 | 38 | 205 | satisfied | performed | performed | A | A: no defect | A |
| 16 | 3 | 2.5 | 38 | 205 | satisfied | performed | performed | A | A: no defect | A |
| 17 | 3 | 2.5 | 38 | 205 | satisfied | performed | performed | A | A: no defect | A |
| 18 | 3 | 2.5 | 38 | 205 | satisfied | performed | performed | A | A: no defect | A |
| 19 | 3 | 2.5 | 38 | 205 | satisfied | performed | performed | A | A: no defect | A |
| 20 | 3 | 2.5 | 38 | 205 | satisfied | performed | performed | A | A: no defect | A |
| 21 | 3 | 2.5 | 38 | 205 | satisfied | performed | performed | B | A: no defect | B |
| 22 | 3 | 2.5 | 38 | 205 | satisfied | performed | performed | A | A: no defect | A |
| 23 | 3 | 2.5 | 38 | 205 | satisfied | performed | performed | A | A: no defect | A |
| 24 | 3 | 2.5 | 38 | 205 | satisfied | performed | performed | A | A: no defect | A |
| 25 | 3 | 2.5 | 38 | 205 | satisfied | performed | performed | A | B: acceptable | A |
| 26 | 3 | 2.5 | 38 | 205 | satisfied | performed | performed | A | B: acceptable | A |
| 27 | 3 | 2.5 | 38 | 205 | satisfied | performed | performed | A | A: no defect | A |
| 28 | 3 | 2.5 | 38 | 205 | satisfied | performed | performed | B | A: no defect | B |
| 29 | 3 | 2.5 | 38 | 205 | satisfied | performed | performed | A | A: no defect | A |
| 30 | 3 | 2.5 | 38 | 205 | satisfied | performed | performed | A | A: no defect | A |
| 31 | 3 | 2.5 | 38 | 205 | satisfied | performed | performed | B | B: acceptable | B |
| 32 | 3 | 2.5 | 38 | 205 | satisfied | performed | performed | A | A: no defect | A |
| 33 | 3 | 2.5 | 38 | 205 | satisfied | performed | performed | A | B: acceptable | A |
| 34 | 3 | 2.5 | 38 | 205 | satisfied | performed | performed | B | B: acceptable | B |
| 35 | 3 | 2.5 | 38 | 205 | satisfied | performed | performed | B | B: acceptable | B |
| 36 | — | — | — | — | — | performed | — | C | C: undercutting | C: (voids) |
| 37 | — | — | — | — | — | performed | — | B | C: undercutting | C: (enhanced |
| | | | | | | | | | | ruggedness) |
| 38 | — | — | — | — | — | performed | performed | B | C: undercutting | C: (enhanced |
| | | | | | | | | | | ruggedness) |
| 39 | — | — | — | — | — | performed | not | B | C: undercutting | C: (enhanced |
| | | | | | | | performed | | | ruggedness) |

*1: Bridged gap with good bead appearance . . . A; bridged gap . . . B; unbridged gap . . . C.
*2: Bead having voids due to burning through and bead with enhanced ruggedness . . . C; bead having gentle undulations . . . B (acceptable level); bead with no problem . . . A.

As illustrated in Table 1 and Table 2, Test No. 1 to No. 33, in each of which weaving had been conducted and the welding current for forming an initial weld bead from the front side had been within the range of 130 to 300 A specified in the present invention, each gave results in which the bridging, the initial-layer weld defects, and the back-side bead shape satisfied the acceptable levels with respect to each groove shape, each welding position, and each kind of shielding gas.

Test No. 34 and Test No. 35, in which weaving had been conducted but the welding currents for forming an initial weld bead had respectively been 130 A and 300 A, which were outside the range specified in the present invention, gave results in which the bridging, the initial-layer weld defects, and the back-side bead shape were all rated as B, on the acceptable levels. Test Nos. 34 and 35 gave results in which the bridging, the initial-layer weld defects, and the back-side bead shape were rated as B, although the welding currents for forming an initial weld bead had been outside the range specified in the present invention. This is presumed to be due to the effect of weaving.

Meanwhile, Test No. 36, in which welding had been conducted without weaving, gave results in which the bridging, the initial-layer weld defects, and the back-side bead shape all did not reach the acceptable levels in terms of undercutting, incomplete penetration, and voids. Test No. 37, in which welding had been conducted without weaving, gave results in which the initial-layer weld defects and the back-side bead shape both did not reach the acceptable levels in terms of undercutting and enhanced ruggedness.

Test No. 38, in which welding had been conducted with normal weaving, gave results in which the initial-layer weld defects and the back-side bead shape both did not reach the acceptable levels because of undercutting and enhanced ruggedness.

Test No. 39, in which normal weaving had been conducted and voltage control at both weaving ends had not been performed, gave results in which the initial-layer weld defects and the back-side bead shape both did not reach the acceptable levels in terms of undercutting and enhanced ruggedness.

Test No. 21, in which the torch angle had been less than (front-side groove angle)/2, gave results in which the bridging and the back-side bead shape were rated as B. Test No. 33, in which the torch angle had exceeded (front-side groove angle)/2+5°, gave results in which the initial-layer weld defects were rated as B.

Test No. 8, in which the extension of the consumable electrode 32 had not been controlled, gave results in which the bridging and the back-side bead shape were rated as B.

Each of Test No. 6, in which the backward movement angle α and the forward movement angle β had respectively exceeded the upper limits of 85° and 250°, and Test No. 7, in which the backward movement angle α and the forward movement angle β had respectively been less than the lower limits of 5° and 185°, gave results in which the bridging was rated as B.

Test No. 9, in which arc voltage control at both weaving ends had not been performed, gave results in which the bridging was rated as B.

Each of Test No. 25, in which the back-side welding current had been lower than the lower limit of 280 A, and Test No. 26, in which the back-side welding current had exceeded the upper limit of 450 A, gave results in which the initial-layer weld defects were rated as B. Test No. 11, in which the ratio of the back-side welding current to the welding current for forming the initial weld bead, (back-side welding current)/(welding current for initial weld bead), had been less than the lower limit of 1.2, gave results in which the bridging, the initial-layer weld defects, and the back-side bead shape were all rated as B, although on the acceptable levels.

Test No. 28, in which the initial weld bead had had a back-side protrusion amount of 4 mm, gave results in which the bridging and the back-side bead shape were both rated as B.

Test No. 31, in which the root gap had exceeded 10 mm and the ratio (value of the root gap)/(welding current for forming the initial weld bead) had exceeded 0.050, gave results in which the bridging, the initial-layer weld defects, and the back-side bead shape were all rated as B.

Meanwhile, each of Test Nos. 1 to 5, No. 10, Nos. 12 to 20, Nos. 22 to 24, No. 27, No. 29, No. 30, and No. 32, in which all the welding conditions had satisfied the ranges of the present invention, gave satisfactory results.

The present invention is based on Japanese patent application No. 2016-225962 filed on Nov. 21, 2016, the contents of which are incorporated herein by reference.

### REFERENCE SIGNS LIST

11 First steel plate
12 Second steel plate
13 Edge surface
14 Flat surface
21 Initial weld bead
22, 23 Weld bead
31 Welding torch
32 Consumable electrode
a Back-side protrusion amount of initial weld bead
G Root gap
L Extension of consumable electrode from welding torch
P Weaving end of first steel plate
P Weaving end of second steel plate
P Midpoint
V First arc voltage
V Second arc voltage
Vₘ Arc voltage at midpoint between both weaving ends
Y Welding direction
α Backward movement angle
β Forward movement angle
θ1 Front-side groove angle
θ Torch angle

1. A gouging-less full-penetration welding method for welding a first steel plate and a second steel plate without performing gouging, wherein the first steel plate and the second steel plate form a single or double bevel groove, and a side where the single bevel groove is open or a side where the double bevel groove has a smaller groove angle is referred to as a front side, the method comprising:
(i) repeating weaving at a welding current of 130 to 300 A between the first steel plate and the second steel plate, thereby forming an initial weld bead comprising a single continuous layer or a plurality of continuous layers between the first steel plate and the second steel plate,
wherein in the weaving, on the front side between the first steel plate and the second steel plate, a welding torch is moved forward in a welding direction to a weaving end of the second steel plate and, after arrival at the weaving end of the second steel plate, the welding torch is moved backward in the welding direction to a weaving end of the first steel plate;
(ii) conducting single- or multi-layer welding from the front side; and
(iii) conducting single- or multi-layer welding from a back side.

2. The gouging-less full-penetration welding method of claim 1,
wherein the initial weld bead is formed by welding with a consumable electrode fed from the welding torch, and
wherein the welding torch has a torch angle within a range of (front-side groove angle)/2 to (front-side groove angle)/2+5°.

3. The gouging-less full-penetration welding method of claim 1,
wherein the initial weld bead is formed by welding with a consumable electrode fed from the welding torch, and
wherein the weaving is conducted so that an extension of the consumable electrode from the welding torch is constant.

4. The gouging-less full-penetration welding method of claim 1, wherein in the weaving:
in moving the welding torch forward in the welding direction to the weaving end of the second steel plate, a forward movement angle β, which is an angle formed by a track of the welding torch and the welding direction, is 185° or more and 250° or less;
in moving the welding torch backward in the welding direction to the weaving end of the first steel plate, a backward movement angle α, which is an angle formed by the track of the welding torch and a direction opposite to the welding direction, is 5° or more and 85° or less; and
the backward movement angle α and the forward movement angle β satisfy a relationship of α>(β−180).

5. The gouging-less full-penetration welding method of claim 1,
wherein in the weaving, at least one of a first arc voltage at the weaving end of the first steel plate and a second arc voltage at the weaving end of the second steel plate is controlled to be higher or lower than an arc voltage at the midpoint between the weaving end of the first steel plate and the weaving end of the second steel plate, so that the first arc voltage is lower than the second arc voltage.

6. The gouging-less full-penetration welding method of claim 1,
wherein the single- or multi-layer welding from the back side is conducted at a back-side welding current of 280 to 450 A, and
wherein a ratio of the back-side welding current to the welding current for forming the initial weld bead, (back-side welding current)/(welding current for initial weld bead), is 1.2 to 2.6.

7. The gouging-less full-penetration welding method of claim 1,
wherein the initial weld bead protrudes on the back side in an amount of less than 4 mm.

8. The gouging-less full-penetration welding method of claim 1,
wherein a root gap between the first steel plate and the second steel plate is 10 mm or less.

9. The gouging-less full-penetration welding method of claim 1,
wherein at least the forming the initial weld bead comprises:
detecting a root gap by sensing using a welding robot before the welding; and
controlling the welding current for forming the initial weld bead depending on the root gap.

10. The gouging-less full-penetration welding method of claim 9, wherein when the root gap exists, the welding current for forming the initial weld bead is controlled so that a ratio of a value of the root gap to the welding current for forming the initial weld bead is 0.050 or less.

11. A weld joint welded by the gouging-less full-penetration welding method of claim 1.
